(19) United States
(12) Patent Application Publication
(10) Pub. No.: US 2019/0016585 A1
(43) Pub. Date: Jan. 17, 2019

(54) CONSUMER WHOLESALE GAS DISCOUNT CARD SYSTEM

(71) Applicant: Michael A. Racusin, Chicago, IL (US)

(72) Inventor: Michael A. Racusin, Chicago, IL (US)

(21) Appl. No.: 16/136,505

(22) Filed: Sep. 20, 2018

Related U.S. Application Data
(63) Continuation-in-part of application No. PCT/US2018/040020, filed on Jun. 28, 2018.
Application No. PCT/US2018/040020 is a continuation of application No. 15/865,891, filed on Jan. 9, 2018.
Application No. 15/865,891 is a continuation of application No. 15/783,138, filed on Oct. 13, 2017.
Application No. 15/783,138 is a continuation of application No. 15/636,241, filed on Jun. 28, 2017.

(51) Int. Cl. B67D 7/30; G06Q 20/28; B67D 7/14

(52) U.S. Cl. CPC B67D 7/303; G06Q 20/28; G06Q 30/0207; B67D 7/14

(57) ABSTRACT

A wholesale gas discount card system allows an oil company to provide a uniform percentage discount across regions where the wholesale price per gallon varies and at the same time allows consumers to get a discount on the retail price per gallon of gas. The wholesale gas discount card system operates as a subscription system in which only subscribing consumers are able to receive discounts at participating retail gas stations. The discount is based upon a predetermined amount of the wholesale price component of the retail gas price per gallon, for example 5%. The percentage wholesale price discounts can vary depending on the gasoline type, i.e. regular, mid-range, premium and diesel. In this way, a wholesaler can control their price margin across regions with varying wholesale price components per gallon. Participating consumers can download a software application onto their smart phone that provides the locations of participating retail gas stations in a given area and the discounted retail gas prices per gallon. Once a retail station is selected, the consumer inserts a discount credit card into the gas dispenser. The system uses the account information from the credit card and the location of the gas pump to process the transaction as the consumer pumps gas into their vehicle. The gas is charged to their credit account. Based upon a predetermined discount, the total discounted cost of the transaction is determined “back office” and credited on the consumer's account and optionally displayed on the pump.

### CROSS REFERENCE TO RELATED APPLICATIONS

This application is continuation-in-part of PCT application no. PCT/US2018/040020, filed on Jun. 28, 2018, hereby incorporated by reference.

### BACKGROUND OF THE INVENTION

### 1. Field of the Invention

The present system relates to a subscription system that allows consumers to participate in a wholesale gas discount card system that provides discounts on the wholesale price component of the retail gas price per gallon. Subscribers are provided with a credit card that allows them to purchase gas at a predetermined percentage discount off the wholesale component of the current retail gas component at participating gas stations.

### 2. Description of the Prior Art

Gas discount cards are known that provide a fixed discount on the retail gas price per gallon to increase sales. The retail gas price is a composite price based upon several price components. These components include; the wholesale gas cost per gallon; federal, state and local taxes per gallon; and local fees per gallon. Local fees include various components including the retail owner's expenses and profit margin.

Each of these price components normally varies by location. Due to these variances, fixed retail gas discounts cannot be implemented as effectively as a per centage discount of the wholesale price component. Since local taxes and various local fees cannot be discounted, any discounts normally come out of the profit on the retail price per gallon. Since the profit varies, the discount could vary proportionately

Gas wholesalers, on the other hand, are known to operate over relatively large regions of the country where the retail gas price components vary substantially. Any discounts provided by the wholesaler on the retail price per gallon of a gallon of gas are normally credited back to the purchaser. Assuming the wholesale gas price across the operating region varies, the wholesaler's profit margin will vary. Thus, fixed discounts on the retail price per gallon are only optimum for oil companies in regions if the wholesale price per gallon is similar.

Thus, there is a need for wholesalers to be able to provide a discount on the retail price of a gallon of gas that is not limited to locations because the wholesale price per gallon is not similar.

### SUMMARY OF THE INVENTION

A wholesale gas discount card system in accordance with the invention solves this problem. The wholesale gas discount card system allows wholesalers to provide a uniform discount across regions where the wholesale price per gallon varies and at the same time allows consumers to get a discount on the retail price per gallon of gas. The wholesale gas discount card system operates as a subscription system in which only subscribing consumers are able to receive discounts at participating retail gas stations. The discount is based upon a predetermined amount of the wholesale price component of the retail gas price per gallon, for example 5%. The percentage wholesale price discounts can vary depending on the gasoline type , i.e. regular, mid-range, premium and diesel. In this way, an oil company can control their price margin across regions with varying wholesale price components per gallon. Participating consumers can download a software application onto their smart phone that provides the locations of participating retail gas stations in a given area and the discounted retail gas prices per gallon. Once a retail station is selected, the consumer inserts a discount credit card into the gas dispenser. The system uses the account information from the credit card and the location of the gas pump to process the transaction as the consumer pumps gas into their vehicle. The gas is charged to their credit account. Based upon a predetermined discount, the total discounted cost of the transaction is determined “back office” and credited on the consumer's monthly statement and optionally displayed on the pump.

### DESCRIPTION OF THE DRAWING

These and other advantages of the present invention will be readily understood with reference to the following specification and attached drawing wherein:

FIG. 1 is a simplified block diagram of wholesale gas discount card system.

FIG. 2 is a software flow chart of consumer application which optionally forms a part of the wholesale gas discount card system.

FIG. 3 is a software flow chart of a server which forms a part of the wholesale gas discount card system.

### DETAILED DESCRIPTION

A wholesale gas discount card system allows an oil companies to provide a uniform discount across regions where the wholesale price per gallon varies and at the same time allows consumers to get a meaningful discount on the retail price per gallon of gas. The wholesale gas discount card system operates as a subscription system in which only subscribing consumers are able to receive discounts at participating retail gas stations. The discount is based upon a predetermined amount of the wholesale price component of the retail gas price per gallon, for example 5%. The percentage wholesale price discounts can vary depending on the gasoline type , i.e. regular, mid-range, premium and diesel. In this way, an oil company can control their price margin across regions with varying wholesale price components per gallon. Participating consumers can download a software application onto their smart phone that provides the locations of participating retail gas stations in a given area and the discounted retail gas prices per gallon. Once a retail station is selected, the consumer inserts a discount credit card into the gas dispenser. The system uses the account information from the credit card and the location of the gas pump to process the transaction as the consumer pumps gas into their vehicle. The gas is charged to their credit account. Based upon a predetermined discount, the total discounted cost of the transaction is determined “back office” and credited on the consumer's current statement and optionally displayed on the pump.

The cost of the discount may be borne solely by the oil company or shared by the wholesaler and the retailer by agreement since the retailer will likely see increased sales from the oil company's discount.

An important part of the wholesale gas discount card system is that is available by subscription. Participating consumers “subscribe” by paying an annual fee to receive a wholesale price component discount at participating retail gas stations.

Subscription systems are popular with consumers and lucrative for wholesalers. Benefits to the wholesaler include increased customer loyalty and additional revenue without the need to deliver any product, thus providing increased cash flow to the wholesaler. For example, Costco®1 is known to have over 90 million members. The annual cost of its membership currently ranges from $60 to $120. Amazon Prime®2 has approximately 100 million members. The cost of its membership is $119. Assuming an annual cost of membership of $100 in the wholesale gas discount card system, 10 million subscribers at an annual fee of $100 would yield 1 billion dollars per year in increased revenue for the oil company. ¹ Costco® is a registered trademark of Costco Wholesale Corporation.² AMAZON PRIME® is a trademark of Amazon Technologies, inc.

In addition to increased revenue, the wholesale gas discount card system allows a wholesaler to control different elastic demand curves. The first elastic demand curve relates to sales of gasoline. In order to increase sales, the wholesaler can increase the wholesale price discount component discount. As the demand increases, the wholesaler can lower the discount. The second elastic demand curve relates to the subscription price. In order to increase the number of subscribers, the annual fee can be lowered. As the demand to subscribe increases, the annual subscription price can be increased.

The wholesale gas discount card system is able to provide significant advantages over discount gas retailers. Costco® effectively competes with regional retail gas stations by offering lower gas prices based upon a slightly lower wholesale gas price and lower margin. However, Costco® provides less availability of its retail gas facilities, thus preventing its subscriber from getting the full advantage of its lower retail gas prices. For example, Costco® only has hundreds of retail gas stations with retail hours and is closed on holidays. Thus, a subscriber on a trip from the western US to the east coast may only come across a handful of Costco® gas stations forcing the subscriber to purchase higher price gas at other retail gas stations. Moreover, Costco does not sell midrange or diesel gasoline.

Oil company retail stations are much more available to consumers. Oil companies have thousands of retail locations. Moreover, most branded retail locations are open 24 hours and are normally open on holidays. Thus, a gas discount issued for use at branded retail locations provide significant advantages for a consumer.

There are two aspects of the wholesale gas discount card system 20. One aspect relates to a software application which provides subscribers with location of participating retail gas stations and the discounted retail prices at those stations. The other aspect relates to the “back office” system that determines the discounted retail price.

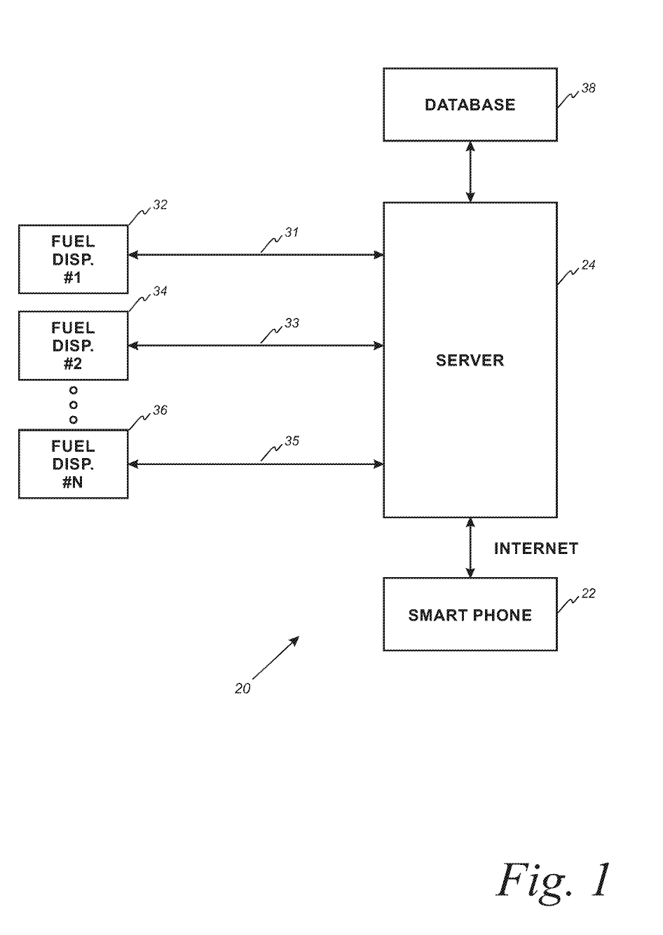

Referring first to FIG. 1, the system 20 includes a server 24 and a database 38 in electronic communication with said server 24. The database 38 stores the consumer's account information including whether the consumer has paid a subscription fee. The database 38 stores the locations of all participating retail stations and the respective discounted retail prices at those stations. The database 38 also stores the retail price per gallon and other price components per gallon including the wholesale price component per gallon for all participating retail gas stations based upon the location of their respective gas pumps 32, 34 and 36. Electronic communication between the gas pumps 32, 34 and 36 and the server is by way of bi-directional communication links 31, 33 and 35.

Subscribing consumers are able to download a software application to their smart phone 22 (FIG. 1) which enables access to the central server 24 by way of the Internet. Access to the server 24 enables consumers to access the server 24 to pay the subscription fee in order to participate in the wholesale gas discount card system and to display nearby participating stations and their respective discounted retail price per gallon on their smart phones 22.

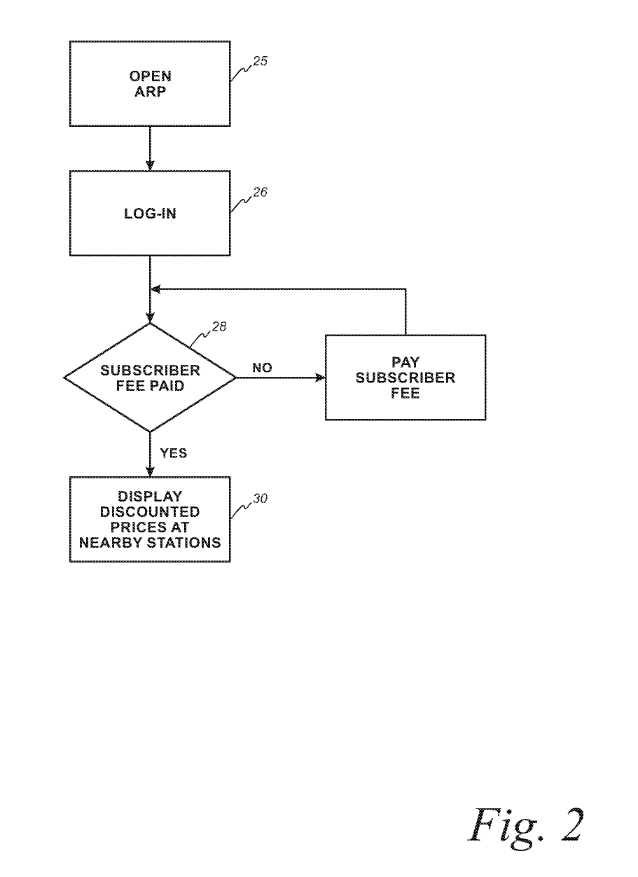

Referring to FIG. 2, in order to access the system, a software application is downloaded onto the user's smart phone 22. Since the wholesale gas discount card system is a subscriber-based system, once a user opens the application on their smart phone 22 in step 25, the user is prompted to log-in in step 26 if the user has an account. If the user does not have an account, the user is prompted to create an account. Once a user logs-in, the application determines if the subscriber fee is paid in step 28. If the subscriber fee is not paid, the system prompts the user for payment of the subscription fee. When the subscription fee is paid, the application displays the discounted retail prices at company owned or company branded retail stations nearby to said smart phone 22, stored in the database 38 based on the GPS coordinates provided by the smart phone 22 in step 30.

In accordance with an important aspect of the invention, wholesale gas discount card system 20 provides a predetermined discount on the retail pump price. Discounted retail gas prices per gallon based upon discounted wholesale price components per gallon is discussed in detail in US Patent Application Publication No. US 2017/0364896, published on Dec. 21, 2017 and PCT application no. PCT/US2018/040020, filed on Jun. 28, 2018, hereby incorporated by reference. The system would thus allow a consumer traveling from the western US to the east coast and to display a multitude of participating stations and their respective discounted retail prices along the way.

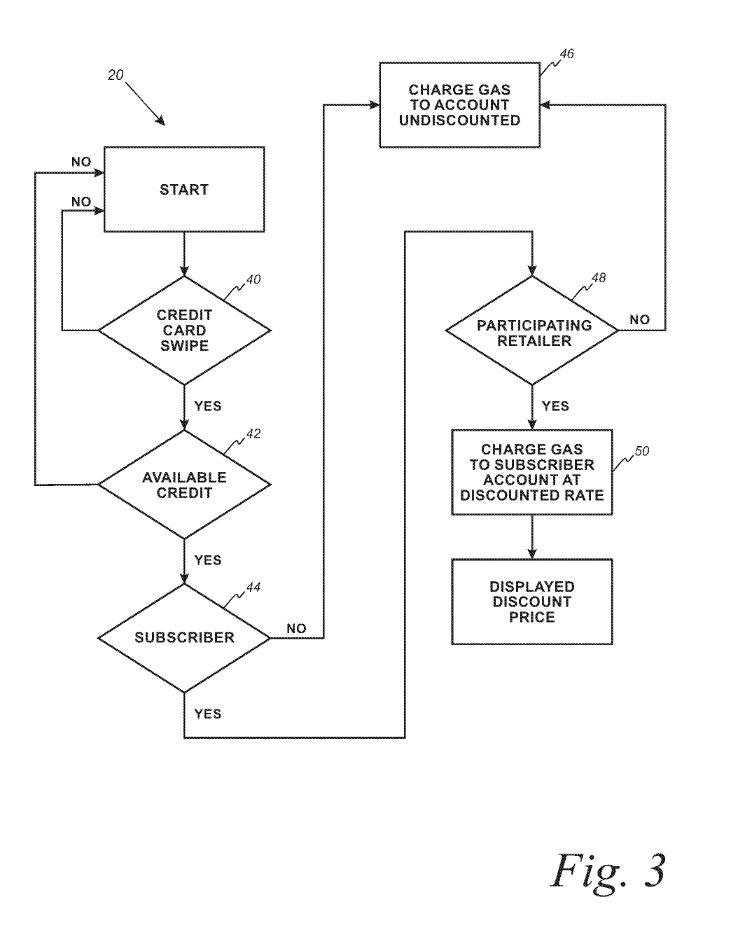

Turning to FIG. 3, a software flow chart for the server 24 is illustrated. As mentioned above, the fuel dispensers, i.e. gas pumps, 32, 34 and 36 are in communication with the server 24 by way of the bi-directional communication links 31, 33 and 35. As such, when a credit card is swiped at one of the fuel dispensers 32, 34 and 36 in step 40, the credit card information including the account number of the card holder and the location of the fuel dispenser is transmitted to the server 24. The server 24 looks up the account information in the database 38 to determine if the account holder has available credit in step 42. If not, the system returns to start and waits for a credit card to be swiped. If the account holder has available credit, the system checks the database 38 to determine if the account holder is a subscriber in step 44. If not, gas is charged to the charge holder account in a conventional manner in step 46.

If the account holder is a subscriber, the system checks in step 48 whether the retailer where the credit card was swiped is a participating retailer. If not, the system proceeds to step 46 and charges the gas in a conventional manner. If the retailer is a participating retailer, the gas is discounted “back office”, as discussed above, and charged to the account holder's account at a discounted rate in step 50. The discounted transaction is then billed to the account holder at a later date. The account is reflected immediately.

Obviously, many modifications and variations of the present invention are possible in light of the above teachings. Thus, it is to be understood that, within the scope of the appended claims, the invention may be practiced otherwise than as specifically described above.

I claim:

1. A wholesale gas discount card system for providing discounts on the retail price per gallon of gas based upon a predetermined discount on the wholesale price of gas, the system comprising:
a server configured to communicate smart phones over the internet;
a bi-directional communication system for enabling the server to communicate with a plurality of gas pumps;
a database for storing account and subscriber information and data of participating retail stations and their respective discounted retail prices per gallon; and
wherein said server is configured to calculate a discounted transaction price based upon a discounted wholesale component price.

2. The system as recited in claim 1, wherein said system is configured to enable a consumer to pay a subscription fee to participate in the wholesale gas discount card system by way of a smart phone.

3. The system as recited in claim 1, wherein said system is configured to enable nearby stations and their discounted retail price per gallon to be displayed on said smart phone.
